(19) United States
(12) Patent Application Publication
(10) Pub. No.: US 2026/0140783 A1
(43) Pub. Date: May 21, 2026

(54) DATA TRANSFER

(71) Applicants: Arm Limited, Cambridge (GB); Alphawave Semi, Inc., San Jose, CA (US)

(72) Inventors: Cesar Aaron RAMIREZ, Pflugerville, TX (US); Viswanath CHAKRALA, Bangalore (IN); Ashok Kumar TUMMALA, Cedar Park, TX (US); Travis Bailey HAMILTON, Cedar Park, TX (US); Charles Andrew GIEFER, Spicewood, TX (US); Abhay TAVARAGIRI, Liberty Hill, TX (US); Randall John PASCARELLA, Round Rock, TX (US); Gopi KRISHNAMURTHY, Plano, TX (US)

(21) Appl. No.: 19/092,472

(22) Filed: Mar. 27, 2025

(30) Foreign Application Priority Data
Nov. 15, 2024 (IN) 202411088580

(51) Int. Cl. G06F 9/50; G06F 13/40

(52) U.S. Cl. CPC G06F 9/5044; G06F 9/5094; G06F 13/4027

(57) ABSTRACT

There is provided an apparatus comprising bridge circuitry to couple processing circuitry to an allocated subset of a plurality of port controllers for connecting the processing circuitry to link partners. The bridge circuitry is configured to perform a data transfer between the processing circuitry and the allocated subset according to a bandwidth quota. The apparatus is provided with control circuitry to receive configuration information identifying the allocated subset, and to allocate a bandwidth share to each port controller identified in the allocated subset. The control circuitry is configured to determine the bandwidth share based on the configuration information. The control circuitry is configured, for each given port controller identified in the allocated subset, to implement a restriction to limit the data transfer between the given port controller and the processing circuitry according to the bandwidth share allocated to the given port controller.

This application claims priority to IN Patent Application No. 202411088580 filed Nov. 15, 2024, the entire contents of which are hereby incorporated by reference.

### TECHNICAL FIELD

The present invention relates to data processing. More particularly the present invention relates to an apparatus, a system, a chip containing product, computer-readable code, and a method.

### BACKGROUND

Some apparatuses are provided with bridge circuitry to couple processing circuitry to port controllers for connecting the processing circuitry to link partners.

### SUMMARY

According to a first aspect of the present techniques there is provided an apparatus comprising:
bridge circuitry configured to couple processing circuitry to an allocated subset of a plurality of port controllers for connecting the processing circuitry to link partners, wherein the bridge circuitry is configured to perform a data transfer between the processing circuitry and the allocated subset according to a bandwidth quota; and
control circuitry configured to receive configuration information identifying the allocated subset, and to allocate a bandwidth share of the bandwidth quota to each port controller identified in the allocated subset,
wherein the control circuitry is configured:
to determine the bandwidth share that is allocated to each port controller based on the configuration information; and
for each given port controller identified in the allocated subset, to implement a restriction to limit the data transfer between the given port controller and the processing circuitry according to the bandwidth share allocated to the given port controller.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system of the second aspect, wherein the system is assembled on a further board with at least one other product component.

According to a fourth aspect of the present techniques there is provided a computer-readable code for fabrication of the apparatus according to the first aspect.

In some configurations the computer readable code is stored on a computer readable storage medium. In some configurations the computer readable storage medium is a non-transitory computer readable storage medium.

According to a fifth aspect of the present techniques there is provided a method comprising:
coupling, with bridge circuitry, processing circuitry to an allocated subset of a plurality of port controllers for connecting the processing circuitry to link partners, wherein the bridge circuitry is configured to perform a data transfer between the processing circuitry and each port controller of the allocated subset according to a bandwidth quota;
receiving configuration information identifying the allocated subset, and allocating a bandwidth share of the bandwidth quota to each port controller identified in the allocated subset, wherein the bandwidth share that is allocated to each port controller is determined based on the configuration information; and
for each given port controller identified in the allocated subset, implementing a restriction to limit the data transfer between the given port controller and the processing circuitry according to the bandwidth share allocated to the given port controller.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates a transaction layer, a data link layer, and a physical layer according to some configurations of the present techniques;

FIG. 4 schematically illustrates a transaction layer, a data link layer, and a physical layer according to some configurations of the present techniques;

FIG. 5 schematically illustrates an apparatus according to some configurations of the present techniques;

FIG. 6 schematically illustrates an apparatus according to some configurations of the present techniques;

FIG. 7 schematically illustrates an apparatus according to some configurations of the present techniques;

FIG. 8 schematically illustrates an apparatus according to some configurations of the present techniques;

FIG. 9 schematically illustrates an apparatus according to some configurations of the present techniques;

FIG. 10 schematically illustrates an apparatus according to some configurations of the present techniques;

FIG. 11 schematically illustrates an apparatus according to some configurations of the present techniques;

FIG. 12 schematically illustrates a sequence of steps carried out according to some configurations of the present techniques;

FIG. 13 schematically illustrates a sequence of steps carried out according to some configurations of the present techniques;

FIG. 14 schematically illustrates a sequence of steps carried out according to some configurations of the present techniques;

FIG. 15 schematically illustrates a sequence of steps carried out according to some configurations of the present techniques; and

FIG. 16 schematically illustrates a system and a chip containing product according to some configurations of the present techniques.

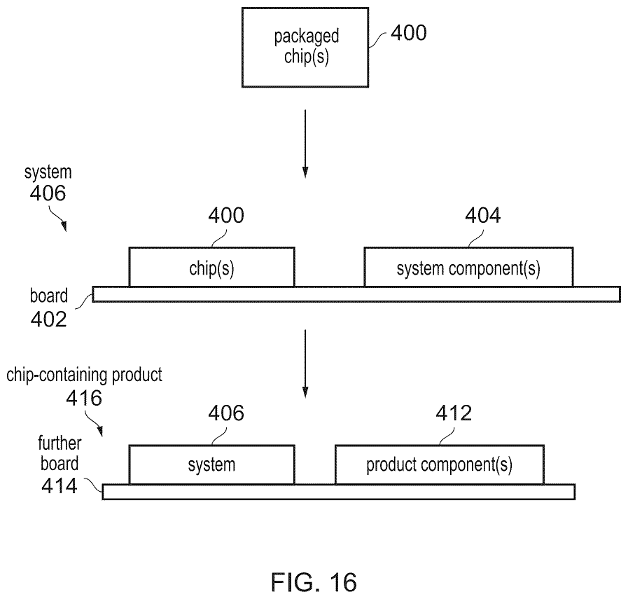

### DESCRIPTION OF EXAMPLE CONFIGURATIONS

Before discussing the configurations with reference to the accompanying figures, the following description of configurations is provided.

According to some configurations of the present techniques there is provided an apparatus comprising bridge circuitry configured to couple processing circuitry to an allocated subset of a plurality of port controllers for connecting the processing circuitry to link partners. The bridge circuitry is configured to perform a data transfer between the processing circuitry and the allocated subset according to a bandwidth quota. The apparatus also comprises control circuitry configured to receive configuration information identifying the allocated subset, and to allocate a bandwidth share of the bandwidth quota to each port controller identified in the allocated subset. The control circuitry is configured to determine the bandwidth share that is allocated to each port controller based on the configuration information. The control circuitry is configured, for each given port controller identified in the allocated subset, to implement a restriction to limit the data transfer between the given port controller and the processing circuitry according to the bandwidth share allocated to the given port controller.

The bridge circuitry is configured to be provided between the processing circuitry and the plurality of port controllers (otherwise referred to as external link controllers) and is configured to transfer data between the processing circuitry and the plurality of port controllers. The rate at which data can be transferred between the processing circuitry and the plurality of port controllers is limited by a bandwidth quota. The bandwidth quota may be due to a restriction on the number of channels for data transfer between the processing circuitry and the plurality of port controllers and/or due to a maximum rate (e.g., a maximum bitrate) at which content can be passed along the channels. The bandwidth quota is shared amongst the port controllers.

The port controllers are provided for enabling the processing circuitry to be connected to link partners (for example, switches or endpoint devices). In general, the number of port controllers that are connected to an link partner is dependent on the particular use case. For example, in some use cases, all of the port controllers may be active and connected to a respective link partner. Alternatively, in other use cases, only a subset of the port controllers may be active and connected to a respective link partner, or none of the port controllers may be active and connected. When only a single link partner is connected, the contention for the bandwidth quota is low as there is no competition from other link partners. However, when two or more link partners are connected (through respective port controllers), then the connected link partners may compete for the available bandwidth.

The inventors have recognised that allowing the link partners to compete for bandwidth within the bandwidth quota can result in an overall reduction in throughput. For example, the bridge lacks awareness of the number of active controllers which can lead to head-of-line blocking, where a queue of packets may be held up behind a packet at the head of the queue which may, for example, be intended for a different link partner to those held up behind it. In addition, competition may result in lower overall performance when arbitration and scheduling choices are made in isolation along the paths between the port controllers and the bridge circuitry. Furthermore, additional queuing and buffering stages may need to be provided throughout the data channels between the bridge circuitry and the port controllers to ensure that the data channels can cope with the demands placed on them by different link partners which may be connected to different link partners and/or may be operating according to different end use cases. The inventors have realised that these problems can be reduced by allocating a bandwidth share to each of the active port controllers. The apparatus is therefore provided with control circuitry that is arranged to receive configuration information identifying an allocated subset of the port controllers that are connected (coupled) to an link partner. The control circuitry may be provided as part of the bridge circuitry or as an external circuit that is coupled to the bridge circuitry. The control circuitry is arranged to determine (e.g., to calculate) a bandwidth share of the bandwidth quota that is to be allocated to each of the port controllers based on the configuration information. For example, the control circuitry may allocate an equal share of the bandwidth quota to each of the allocated port controllers (i.e., the port controllers in the allocated subset) and may choose to allocate a zero share of the bandwidth quota to each of the port controllers that has not been allocated (i.e., the port controllers that are not in the allocated subset). The control circuitry may share out the entire bandwidth quota or may retain some bandwidth quota for other communication purposes. Further details on the bandwidth share and how it is allocated will be provided below.

The control circuitry is further arranged to implement a restriction on the bandwidth usage by each port controller in the allocated subset to prevent those port controllers in the allocated subset from exceeding the bandwidth share allocated to them. The control circuitry may be further arranged to restrict the bandwidth used by the port controllers that are not in the allocated subset, i.e., to ensure that zero bandwidth is used by the port controllers or that a minimum bandwidth share is allocated to those port controllers that are not in the allocated subset, for example, to provide a minimum level of communication between the bridge circuitry and port controllers that have not been allocated. The restriction of the bandwidth usage prevents the port controllers from exceeding their bandwidth share even if there is available bandwidth (for example, bandwidth that has been allocated to a different one of the port controllers but that is not being used). The restriction ensures that there is bandwidth available for each of the port controllers that can be utilised in the event of a sudden increase in the bandwidth requirements by one of the port controllers that was previously not utilising its bandwidth share. As a result, the overall throughput can be increased and instances of content being stalled for one or more of the port controllers due to high bandwidth requirements of another one or more of the port controllers can be reduced.

Whilst the bandwidth share provided to each of the port controllers can, in some configurations, be equal, in some configurations at least two of the plurality of port controllers are configured to provide external communication links to respective ones of the link partners, each of the external communication links having a potential bandwidth different from one another; the configuration information identifies the potential bandwidth provided by each of the port controllers; and the bandwidth share allocated to each port controller is dependent on the potential bandwidth provided by each of the port controllers. The bridge circuitry may be connected to several different port controllers, each capable of providing a different potential bandwidth for communication with the respective one of the link partners. For example, a first port controller may be configured to provide a bandwidth that is 2 times, 4 times, 8 times, or 16 times greater than the bandwidth that can be provided by a second port controller. Such configurations may be provided to facilitate different link partners (which may have different data transfer requirements) being connected to the processing circuitry (via the port controllers and the bridge circuitry). The allocation of an equal share of bandwidth to port controllers providing different potential bandwidths may result in an unused portion of the bandwidth share allocated to the controller having a relatively low potential bandwidth and an insufficient bandwidth share being allocated to the controller having a relatively high potential bandwidth. The provision of configuration information that identifies the potential bandwidth of each of the port controllers therefore enables the control circuitry to determine the bandwidth share allocated to each of those controllers in dependence on the potential bandwidth and can result in an improved overall throughput.

In some configurations the control circuitry is configured to determine the bandwidth share allocated to the given port controller based on a ratio of the potential bandwidth of the given port controller to a sum of the potential bandwidth of all port controllers in the allocated subset. In other words, the control circuitry may calculate a total relative bandwidth requirement by summing the potential bandwidths of each of the allocated subset of port controllers. The control circuitry may also be configured to calculate the bandwidth share allocated to a given one of the port controllers by multiplying the bandwidth quota by the potential bandwidth for the given one of the port controllers and dividing it by the total relative bandwidth requirement. This approach ensures that a port controller having a potential bandwidth that is N times the potential bandwidth of another port controller will receive N times the bandwidth share of the another port controller. Thus, the bandwidth shares allocated to the allocated port controllers can be matched to the potential bandwidth of those controllers.

In addition, or as an alternative, in some configurations at least one port controller of the plurality of port controllers is operable in a plurality of possible configurations, each of the plurality of possible configurations providing a different potential bandwidth; and the control circuitry is configured to determine the potential bandwidth identified in the configuration information for the at least one port controller based on the configuration in which the at least one port controller is operating. In other words, the bridge circuitry is coupled to the plurality of port controllers which are configured to manage bifurcated streams of external link protocol packets. For example, the bifurcated streams may comprise streams of external link protocol packets to be routed over respective subsets of lanes within a given external link interface (physical data channels within the given external link interface). Bifurcation is a technique which may be supported by certain external link protocols to enable a single external connector slot to be partitioned to be shared by multiple devices. Each bifurcated stream may typically have a respective port controller. The bridge circuitry may be implemented at a point in processing flow where the bifurcated streams have converged, so the bridge circuitry may be shared between the port controllers associated with each bifurcated stream. In some configurations only one, or only a subset, of the port controllers may be operable in a plurality of configurations (otherwise referred to as a plurality of modes). In other configurations all of the port controllers may be operable in a plurality of different modes. Where a plurality of the port controllers are each operable in a plurality of different modes, some of the port controllers may be operable in a greater number of different modes than other ones of the port controllers. The mode of operation of the port controllers may be controlled by the processing circuitry, the bridge circuitry, the port controller, or by the link partner that is coupled to (connected to) the port controller. By identifying the potential bandwidth in the configuration information, the control circuitry is able to tailor the bandwidth share based on the mode of operation of the port controller. As a result, the same port controller may receive a larger bandwidth share when operating in a mode that has a larger potential bandwidth and may receive a smaller bandwidth share when operating in a mode that has a smaller potential bandwidth.

Whilst the restriction on the data transfer between the port controllers and the bridge circuitry may be implemented in a variety of different ways, in some configurations the bridge circuitry is configured to implement the restriction by multiplexing between the data transfer for each port controller of the allocated subset. The multiplexing may be implemented based on the available channels for transferring data between the processing circuitry and the port controllers, for example, with some channels being provided to one port controller and some channels being provided to another port controller. In some configurations the multiplexing is time division multiplexing. The control circuitry may separate individual communication streams based on the port controller that is involved in the communication stream, and may allocate a portion of the available time for communicating to each of the communication streams based on the bandwidth allocation. For example, where a first port controller has N times the potential bandwidth of a second port controller then the control circuitry may allocate either N times as many time slots to the first port controller compared to the second port controller, or the control circuitry may allocate, to the first port controller, a time slot that is N times longer than the time slot allocated to the second port controller. The use of multiplexing techniques including time division multiplexing reduces the likelihood of head-of-line blocking occurring as there are specific allocated slots in which each of the port controllers can communicate with the processing circuitry.

In some configurations the control circuitry configured to allocate the bandwidth share to each port controller dynamically based on one or more system parameters. For example, the bandwidth share may be reallocated based on one or more of the link partners connected to the port controllers going offline or being put into a mode in which they require less bandwidth. Alternatively, the bandwidth allocation may be varied based on one or more usage statistics collected during operation of the apparatus. In some configurations the one or more system parameters comprises at least one of: thermal parameters indicative of thermal conditions of the link partners coupled to each port controller of the allocated subset; error conditions indicated on the link partners coupled to each port controller of the allocated subset; and link quality parameters indicative of a stability of an external communication link between each port controller and the link partners. For example, each allocated port controller may be configured to determine a stability of the link to a respective link partner and to provide feedback to the control circuitry when a link instability is detected. The control circuitry may respond to an instability, for example, by modifying the bandwidth share allocated to that port controller. For example, the bandwidth share allocated to the port controller may be reduced in response to the detection of the link instability.

In some configurations the control circuitry configured to allocate the bandwidth share to each port controller statically based on a boot time parameter. The bandwidth share allocation may be defined during part of the boot processes of the apparatus and may remain fixed until the system is rebooted.

In some configurations the control circuitry is responsive to a congestion indication that an amount of data stored in a buffer associated with one of the port controllers of the allocated subset has exceeded a threshold, to reduce transmission of outbound data to that one of the port controllers. The control circuitry may reduce transmission by buffering outbound data and, subsequently, transmitting the buffered data in response to a determination that the amount of data buffered by the port controller has reduced. The reduction of the transmission may comprise preventing all outbound data to that one of the port controllers or reducing the bandwidth share allocated to that one of the port controllers. Furthermore, the control circuitry may reallocate the bandwidth share of the port controller in response to the indication to increase the bandwidth availability to the other port controllers.

In some configurations each of the plurality of port controllers is configured to control communication, via an external communication link for communicating with one of the link partners, of external link protocol packets defined according to an external link protocol. The external link protocol may impose certain transaction ordering rules which restrict ordering between respective data access transactions corresponding to external link protocol packets communicated with the link partner on the external communication link. For example, the external link protocol may define various transaction classes (e.g. non-posted requests requiring a completion response, posted requests not requiring a completion response, and completion responses), and may impose class-based ordering rules which define, depending on which class of transactions a given earlier transaction and a given later transaction belong to, whether the given later transaction is allowed to bypass the given earlier transaction. These ordering rules may in some cases be stricter than ordering requirements imposed by the protocols used by the processing circuitry, so some additional ordering enforcement may be applied that would not be applied if the only ordering requirements were those enforced by the processing circuitry.

In some configurations the bridge circuitry is coupled to each of the plurality of port controllers via an internal communication link configured to use an internal link protocol, different from the external link protocol, to transport the external link protocol packets between the bridge circuitry and the port controller. In some examples, the internal link protocol supports transmission of a plurality of external link protocol packets in a single flit defined according to the internal link protocol. This can be helpful for improving bandwidth on the internal communication link, which may be important for keeping up with increasing transfer rate demands imposed by the latest versions of the external link protocol. The term “flit” is short for flow digit and refers to the smallest non-divisible unit of data for which independent control of routing is offered by the internal communication link (hence, while one flit may be routed with a communications path or at a timing controlled independently of the path/timing used for another flit, it is not possible to independently control the path taken by, or the timing of transmission, for respective subsets of bits within a flit). In some examples, the internal communication link supports transfer of at least 2048 bits of data per flit. This may be a communication rate which is higher than supported by many typical transfer interface protocols.

In one particular example, the internal link protocol comprises CXS (the AMBAR CXS, Credited extensible Stream, streaming interface protocol provided by Arm® Limited). CXS a protocol-agnostic transport interface that enables multiple external link protocol packets to be transferred per internal link protocol flit over shared wires (e.g. shared between read and write transactions), so can be particularly suited to enabling a reduction in the hardware cost of implementing wiring while still supporting the transfer bandwidths required by the latest versions of external link protocols. However, it will be appreciated that other internal link protocols could also be used. For example, an alternative internal link protocol that could be used may be the Streaming Fabric Interface (SFI) provided by Intel.

In some configurations the external link protocol comprises an input/output (I/O) interface protocol. For example, the external link protocol may be an expansion bus interface which enables connection between a given chip within a host compute system and link partners such as peripheral (I/O) devices or other chiplets of a distributed multi-chip compute system.

In some configurations the external link protocol comprises a PCIe-based protocol. The PCIe-based protocol may be derived from the PCIe (Peripheral Component Interconnect Express) standard. For example, the PCIe-based protocol may be PCIe itself, or other protocols such as CXL (Compute Express Link) which is derived from PCIe. The external link protocol may comprise a layered protocol, which is based on multiple layers of packet formatting rules, with one layer encapsulating, with additional packet headers/footers, a packet defined according to a preceding layer of the protocol. Examples of layered protocols include the PCIe-based protocols mentioned above as well as other protocols such as the AMBA® CHI Chip-to-Chip (C2C) protocol provided by Arm® Limited, which is used for chip-to-chip communication in a multi-chip compute system.

In some configurations the external link protocol packets comprise PCIe transaction layer packets. The PCIe specification may also define a data link layer and physical layer, but any framing information for transaction layer packets encoded according to the data link layer or physical layer may be removed prior to the PCIe transaction layer packets being routed over the internal communication link to the bridge circuitry. Hence, the external link protocol packets may comprise the transaction layer packets as defined by PCIe. It is not necessary for the bridge circuitry to consider encoding/decoding of other layers such as the data link layer and physical layer.

Whilst in some configurations the bandwidth quota may be a total bandwidth quota (i.e., a quota for both inbound and outbound content), in some configurations the control circuitry is outbound control circuitry, the bandwidth quota is an outbound bandwidth quota, and the bandwidth share is an outbound bandwidth share of the outbound bandwidth quota for outbound data transferred from the processing circuitry to the allocated subset; and the internal communication link comprises inbound control circuitry configured to allocate an inbound bandwidth share of an inbound bandwidth quota for inbound data transferred from the allocated subset to the processing circuitry. The bandwidth share for inbound data may therefore be determined by the internal communication link separately from the bandwidth share for the outbound data.

In some configurations the inbound bandwidth quota and the outbound bandwidth quota are different. For example, the total quota for incoming data may be larger than or smaller than the total quota for the outgoing data.

In some configurations the inbound bandwidth share and the outbound bandwidth share may be allocated based on a same set of rules or criteria. However, in some configurations the inbound control circuitry allocates the inbound bandwidth share independent from the outbound control circuitry. The outbound control circuitry and the inbound control circuitry may therefore operate independently from one another and according to different rules or criteria.

Whilst in some configurations the inbound bandwidth share and the outbound bandwidth share for a given port controller may be the same, in some configurations, for at least one port controller in the allocated subset, the outbound control circuitry and the inbound control circuitry are configured to support an inbound bandwidth share different from the outbound bandwidth share. The inbound control circuitry and the outbound control circuitry may therefore adapt the respective bandwidth shares based on different criteria and may balance the respective bandwidth shares to generate an improved overall throughput.

Whilst, in some configurations, the apparatus may be provided as bridge circuitry configured to be coupled to the processing circuitry and the port controllers, in some configurations the apparatus comprises the plurality of port controllers, and an internal interface configured to couple each of the plurality of port controllers to the bridge circuitry.

In some configurations the port controller comprises data link layer encoding/decoding circuitry configured to encode/decode PCIe data link layer information for transporting on the external communication link. For example, the PCIe data link layer information could include data link layer packets (DLLPs) and/or data link layer framing information encoded into framing bits around a transaction layer packet (TLP). Hence, the port controller may be the entity that is responsible for encoding and decoding according to the data link layer defined in the PCIe standard. The port controller does not need to be responsible for encoding or decoding according to the transaction layer of PCIe (since it may be the bridge circuitry and the link partner that are respectively responsible for encoding and decoding transaction layer packets). Also, the port controller does not need to be responsible for encoding or decoding a physical layer of the PCIe specification, as this may be done by a separate physical layer controller (PHY controller).

Some configurations will now be described with reference to the figures.

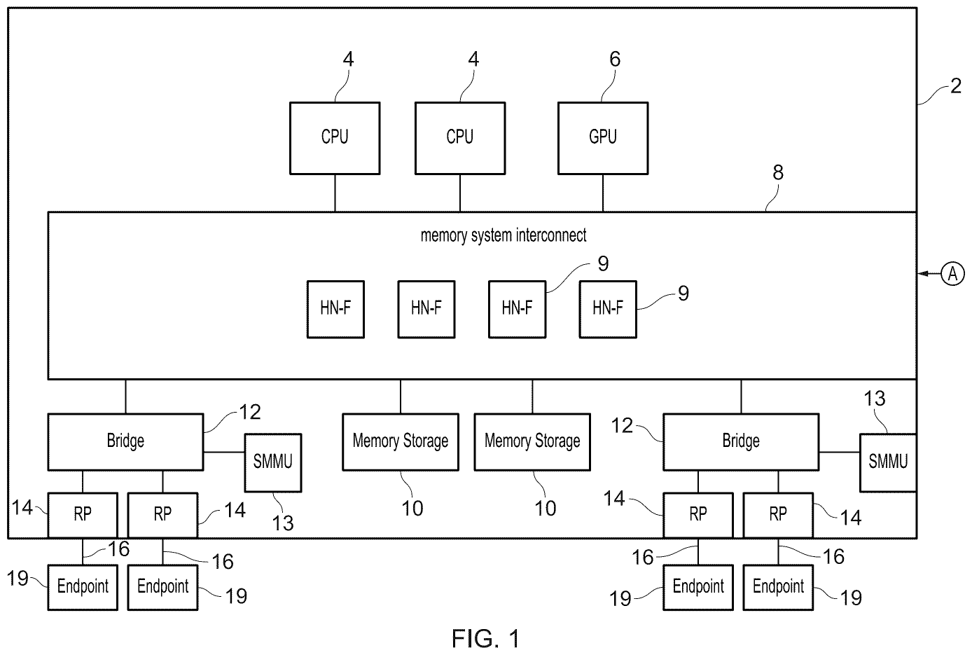

FIG. 1 illustrates an example of a data processing system comprising one or more integrated circuits 2. While FIG. 1, for example, shows a system with two interconnected integrated circuits (chiplets) 2 connected by a chip-to-chip link 22, other examples may be a system-on-chip implemented on a single integrated circuit 2. Also, while in this particular example, both integrated circuits 2 comprise bridge circuitry and an external port controller as described earlier, it is not essential for every integrated circuit 2 in the system to comprise this circuitry, and some examples could include at least one integrated circuit 2 which does not have such bridge circuitry or external port controller at all, or which has bridge circuitry or an external port controller that operates in a different manner to that described above.

A given integrated circuit 2 comprises a number of compute circuit units 4, 6, such as one or more central processing units (CPUs) 4 and one or more graphics processing units (GPUs) 6. While FIG. 1 shows an example two CPUs 4 and one GPU 6 per integrated circuit 2, other numbers and types of compute units may be provided. Furthermore, each integrated circuit 2 in a multi-chip compute system may have a different number of compute units and/or different types of compute units.

The compute circuit units 4, 6 share access to a memory system comprising memory storage circuitry 10, which is accessible via a memory system interconnect 8 which may implement a coherent memory system interconnect protocol, such as AMBA® CHI, or a non-coherent memory system interconnect protocol, such as AMBAR AXI. If the memory system interconnect 8 implements a coherent memory system interconnect protocol, then the memory system interconnect may have at least one instance of home node circuitry 9 to determine responses to memory system transactions based on snooping coherency state of data cached in the private caches of the compute circuit units 4, 6. For example, the home node circuitry 9 may be responsible for generating, in response to a read/write access to a given address initiated by one requester, snoop requests for snooping nodes which could hold cached data for that address. Any known home node/coherency protocol technique may be used to maintain cache coherency in the system.

The integrated circuit 2 may have at least one root port 14 acting as an externally facing interface for communication with one or more link partners (generically labelled 18 in subsequent drawings), such as endpoint devices 19 or switches 20. For a given root port 14, the corresponding link partner 19, 20 is located off-chip on a separate integrated circuit from the integrated circuit 2 comprising that root port 14. Communications with the link partner are via an external communication link 16 based on an external link protocol, which may be an I/O protocol such as PCIe, CXL, AMBA® AXI C2C, etc. The link partner may be any externally located device separate from the integrated circuit 2. For example, examples of link partners may include endpoint devices 19 such as peripherals such as user interface controllers, network interface controllers, controllers for interacting with external memory storage devices, etc. A link partner could also be another system-on-chip similar to the apparatus 2 itself, within a distributed compute system comprising multiple such apparatuses 2 (similar to the relationship between the chiplets 2 connected via the chip-to-chip link 22 as shown in FIG. 1). Some root ports 14 may be coupled via the external communication link 16 to multiple endpoints 19 accessible via a switch 20 (the switch 20 and endpoints 19 not being part of the apparatus 2 itself). Hence, in some cases, the switch 20 acts as the link partner of the root port 14.

While FIG. 1 shows an example where the root port circuitry 14 is on the same integrated circuit 2 as other parts of the integrated circuit 2 for which it acts as an interface to the external endpoint 18, it is also possible that the root port circuitry 14 could be implemented on a separate chiplet from other parts of its associated integrated circuit 2, with a chip-to-chip link 22 between the root port 14 and rest of the integrated circuit 2.

The external link protocol used on the external communications link 16 may define read/write transactions in a different manner to the protocol used by the memory system interconnect 8 that links compute circuitry 4, 6 to memory storage 10 within the integrated circuit 2. Therefore, bridge circuitry 12 may be provided between a root port 14 and the memory system interconnect 8, to map between read/write memory access transactions defined in external link protocol packets on the external communications link 16 and memory system interconnect transactions according to the protocol used on the memory system interconnect 8.

It will be appreciated that FIG. 1 shows just one example arrangement for a processing system, giving an example context in which bridge circuitry 12 may be provided. However, other examples may implement a different configuration of the bridge circuitry 12 relative to other units (e.g. with additional intermediate units between the read port 14 and bridge circuitry 12).

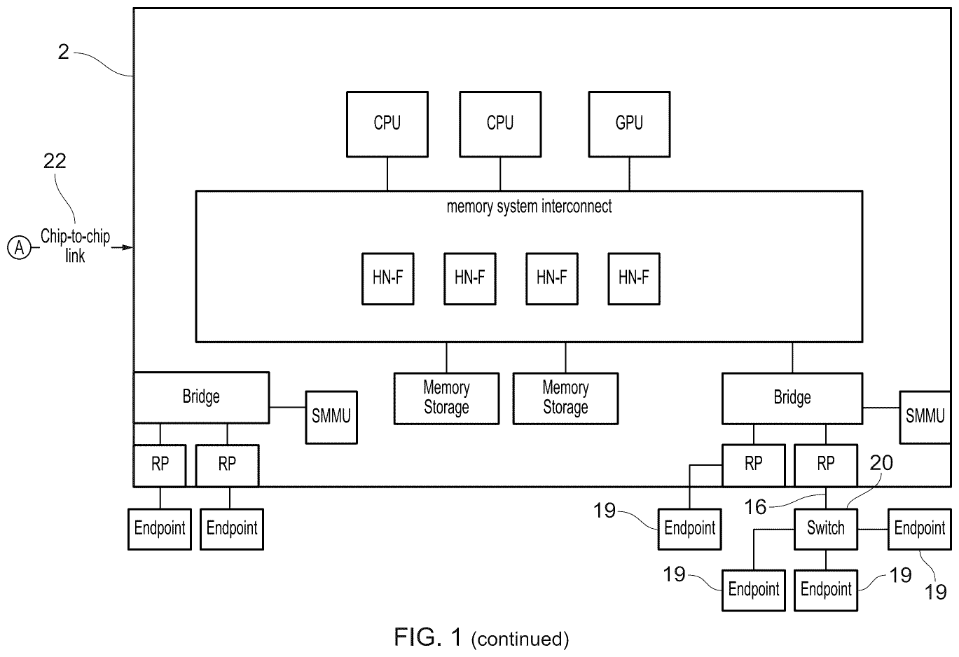

FIG. 2 schematically illustrates an example of different protocols involved in respective communication links in use within the system of integrated circuits 2 shown in FIG. 1. A port controller 15 is provided within the root port 14 for controlling the external port at the boundary of apparatus 2 that interfaces with the external communications link 16. The port controller 15 communicates with a link partner 18 (e.g. an endpoint 19 or switch 20) according to an external link protocol, e.g. PCIe or another I/O protocol.

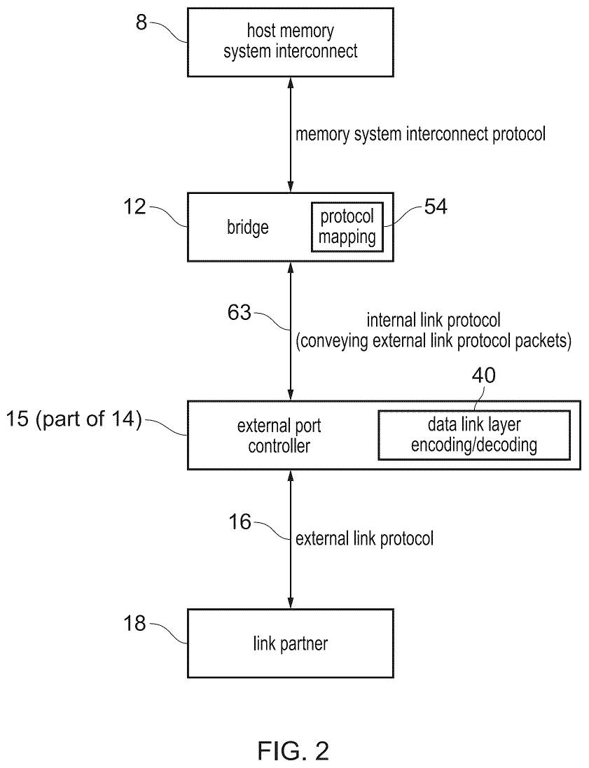

As shown in FIG. 3, the PCIe protocol is a layered protocol which includes a transaction layer, a data link layer and a physical layer.

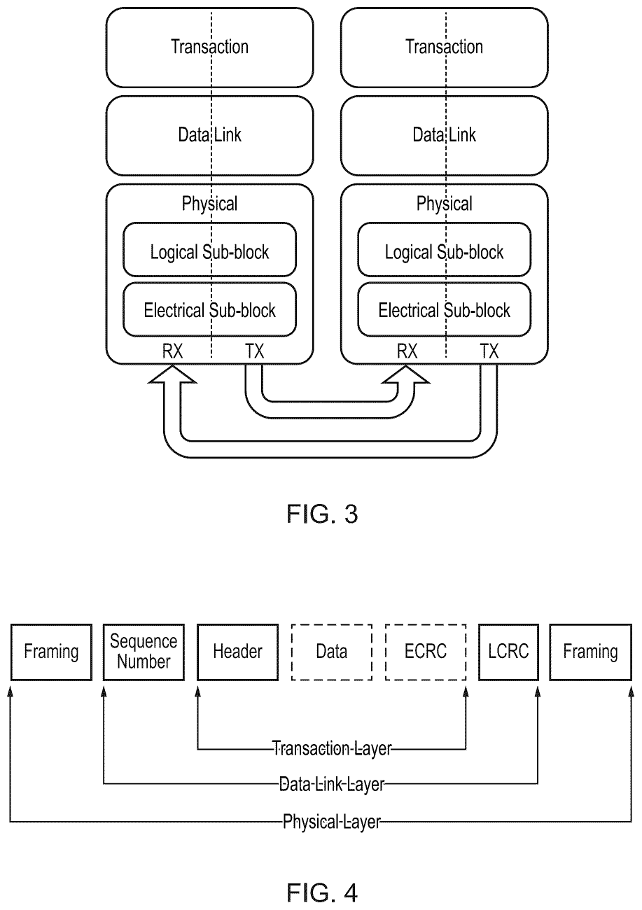

The transaction layer defines a transaction layer packet format which distinguishes various classes of transactions, including posted transactions (write requests which do not require a completion response), non-posted transactions (read requests or write requests which do require a completion response) and completion transactions (completions sent in response to non-posted read or write requests). The transaction layer packet format has an encoding which differentiates read and write transactions. As shown in FIG. 4, a transaction layer packet may comprise a packet header defining parameters of the transaction, such as transaction type (posted/non-posted/completion, read/write, etc.), a target memory address of the transaction, data payload length, and other attributes (e.g. a relaxed ordering attribute specifying whether a more relaxed ordering model than the stronger default ordering rules is appropriate for this transaction). Optionally, the transaction layer packet includes payload data (e.g. read data for a read transaction response or write data for a write transaction request). Payload data may not be needed for some transactions such as read requests or write completion responses. The transaction layer packet encoding can also optionally include an error correcting code (e.g. end to end cyclic redundancy check, ECRC, code) to protect against transmission errors affecting the transaction layer encoding.

The data link layer is responsible for link management and data integrity, including error detection and error correction, so adds a link layer cyclic redundancy check code (LCRC), in addition to the ECRC if an ECRC is provided by the transaction layer. As shown in FIG. 4, the data link encapsulates the transaction layer packet using framing information specifying a sequence number and the LCRC. The data link layer may also provide data link layer packets (DLLPs) which are separate from the transaction layer packets and are communicated over the external communication link.

The Physical Layer specifies circuitry required for physical interface operation, including driver and input buffers, parallel-to-serial and serial-to-parallel conversion, phase locked loops (PLLs), and impedance matching circuitry. The physical layer circuitry adds framing symbols to the transmitted packets, which enable a receiver to detect the start and end of packets.

Hence, there may be a number of layers of encoding/decoding applied at the interfaces to the external communication link. Referring again to FIG. 2, responsibility for encoding/decoding the transaction layer packet data may lie with the bridge circuitry 12 and a link partner 18 respectively (although the port controller 15 could optionally have some circuitry for checking that transaction layer packets are correctly formed). More particularly, within the bridge circuitry 12, protocol mapping circuitry 54 may be provided to map between the transaction layer packets of the external link protocol and the memory system interconnect transactions of the memory system interconnect protocol. Responsibility for encoding/decoding the data link layer packet data lies with the link partner 18 and data link layer encoding/decoding circuitry 40 implemented at the port controller 15 within the root port 14. Responsibility for encoding/decoding the physical layer packet data lies with the link partner 18 and a PHY controller (not shown in FIG. 2) that is implemented within the root port 14.

Hence, for inbound transactions received from the link partner 18 requesting access to the host memory system 10 of the apparatus, the protocol mapping steps are as follows:
the link partner 18 (or an endpoint device that is in communication with the link partner 18) generates the transaction/data link/physical layer packet encoding according to the external link protocol, and the link partner 18 transmits the encoded packets across the external communication link 16;
a PHY controller (not shown in FIG. 2) decodes the physical layer of the transmitted packets;
data link layer decoding circuitry 40 within the external port controller 15 decodes data link layer packets of the transmitted packets, and decodes/removes any data link layer framing information from transaction layer packets defined according to the external link protocol;
the external port controller 15 transmits the transaction layer packets to the bridge circuitry 12 as payload data transmitted within an internal link protocol used for an internal communication link 63 between the bridge 12 and the external port controller 15;
the bridge circuitry 12 decodes the transaction layer packets (defined according to the external link protocol but transported as payload data in at least one flit transmitted according to the internal link protocol), and uses its protocol mapping circuitry 54 to map any read/write requests or other transactions defined in those packets to corresponding transactions defined according to the memory system interconnect protocol, which are forwarded to the memory system interconnect 8 for servicing by the host's memory system.
   On the other hand, for outbound transactions to be transmitted to a link partner 18, e.g. generated based on memory system interconnect transactions to addresses mapped to the root port 14, the protocol mapping steps are as follows:
in response to receipt of a transaction from the memory system interconnect 8 (defined according to the memory system interconnect protocol), the protocol mapping circuitry 54 at the bridge circuitry 12 generates corresponding transaction layer packets according to the external link protocol used on the external communication link 16 (e.g. with read/write transactions mapped to corresponding encodings of read/write transactions in the external link protocol);
the bridge circuitry 12 transmits the external link protocol transaction layer packets on the internal communication link 63, as payload data accompanied by control information defined according to the internal link protocol;
the external port controller 15 extracts the transaction layer packets from the payload data conveyed on the internal communication link, and uses its data link layer encoding/decoding circuitry 40 to append data link layer encoded framing information (e.g. the sequence number and LCRC as shown in FIG. 4) to the transaction layer packets. The external port controller 15 may also be responsible for generation of any data link layer packets (DLLPs);
the PHY controller of the root port 14 encodes the physical layer of the external link protocol packets (as a wrapper around the framed transaction layer packet generated by data link layer encoding/decoding circuitry 40), and transmits the physical layer packets on the external communication link 16 to the link partner 18.

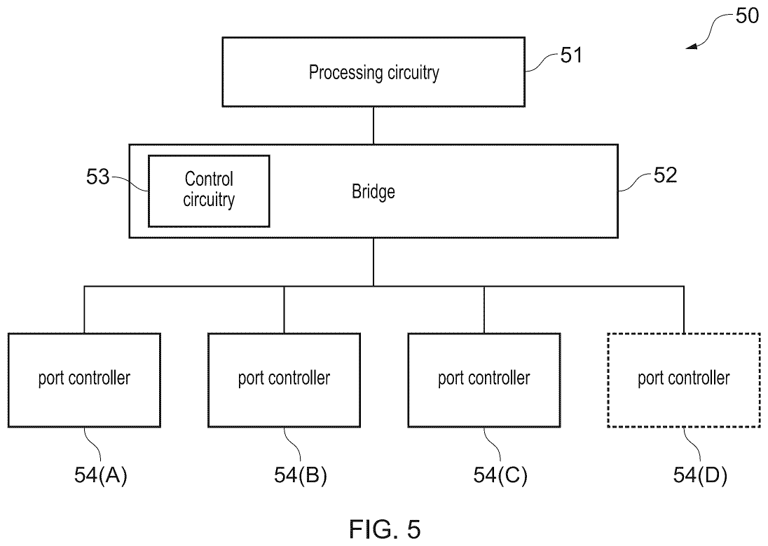

FIG. 5 schematically illustrates an apparatus 50 according to some configurations of the present techniques. The apparatus comprises bridge circuitry 52 coupled to processing circuitry 51 and a plurality of port controllers 54. In the illustrated configuration, the processing circuitry 51 and the port controllers do not form part of the apparatus 50, but are included to illustrate their interaction with the bridge circuitry 52. The apparatus 50 is also provided with control circuitry 53 which, in the illustrated configuration, is provided within the bridge circuitry 52, but in alternative configurations may be provided external to the bridge circuitry 52.

The bridge circuitry 52 is configured to couple the processing circuitry 51 to the port controllers 54 to enable data (which may include data representative of instructions) to be transferred between the processing circuitry 51 and the port controllers 54. The port controllers 54 are each provided for connecting the processing circuitry 51 to link partners (not illustrated). In the illustrated configuration, four port controllers are provided: a first port controller 54(A), a second port controller 54(B), a third port controller 54(C) and a fourth port controller 54(D).

Dependent on the particular use case, the number of port controllers 54 that are coupled to a respective link partner may change. For example, in the illustrated configuration, the first port controller 54(A), the second port controller 54(B) and the third port controller 54(C) are each allocated to a respective link partner. The fourth port controller 54(D) is not connected to an link partner. The allocated subset of the port controllers therefore includes the first port controller 54(A), the second port controller 54(B), and the third port controller 54(C). The fourth port controller 54(D) is not in the allocated subset (and, hence, is illustrated using a dashed line) because it is not connected to an link partner.

The control circuitry 53 is configured to receive configuration information identifying the allocated subset (i.e., specifying which of the port controllers 54 are allocated). The control circuitry 53 is responsive to receipt of the configuration information to allocate a bandwidth share of a bandwidth quota to each of the plurality of link partners 54 in the allocated subset. In the illustrated configuration the control circuitry 53 is configured to share the bandwidth quota between the first port controller 54(A), the second port controller 54(B), and the third port controller 54(C). The fourth port controller 54(D), which is not in the allocated subset, is not allocated a share of the bandwidth quota.

The processing circuitry 51 is therefore able to exchange data with the link partners via the bridge circuitry 52 and the port controllers 54. The control circuitry 53 controls the allocation of bandwidth to restrict (limit) the bandwidth usage by each to the port controllers 54 to the bandwidth share allocated to that one of the port controllers 54.

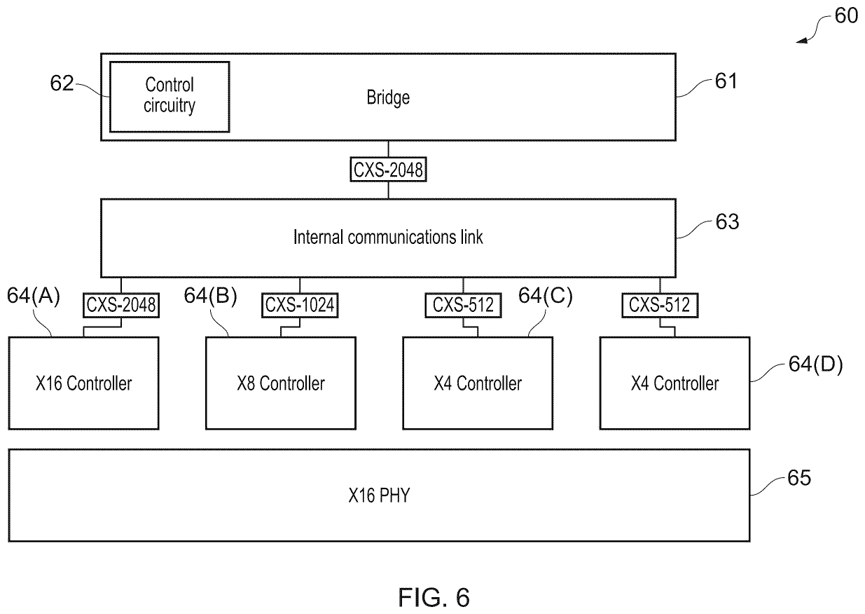

FIG. 6 shows an apparatus 60 in which a single 16-lane physical external link port is controlled by a 16 lane PHY controller 65, but its 16 lanes are capable of being sub-divided into bifurcated streams of packets managed by respective port controllers 64. For instance, the example of FIG. 6 includes a X16 port controller 64(A) used when all 16 lanes of the physical communications link are used in a non-bifurcated manner, and an X8 controller 64(B), a first X4 controller 64(C), and a second X4 controller 64(D) which can be used in a bifurcated mode of operation to control communications on 8 lanes, 4 lanes and 4 lanes respectively. Each of the port controllers 64 communicates, via the internal communications link 63, with the coherent bridge circuitry 61. The bandwidth available in a communications link to a given port controller 64 scales with the bandwidth expected to be supported by that controller, e.g. with the X16 port controller 64(A) having a 2048-bit CXS datapath for both inbound and outbound channels, while the X8 port controller 64(B), the first X4 port controller, and the second X4 port controller 64(D) have 1024-bit, 512 bit, and 512-bit CXS datapaths respectively. Here, the data width of a given channel refers to the width of the data payload passed on the channel, excluding any accompanying control information. Communication between the bridge circuitry 61 and the internal communications link 63 comprises a 2048-bit CXS datapath (a total bandwidth quota) which may be bifurcated into plural bandwidth shares dependent on the configuration of the port controllers 64. For example, where the X16 port controller 64(A) is operated in a X8 mode, the X8 port controller 64(B) is operated in a X8 mode, and each of the first X4 port controller 64(C) and the second X4 port controller 64(D) are not allocated, the control circuitry 62 receives configuration information indicating this allocation and allocates a bandwidth share to each of the X16 port controller 64(A) and to the X8 port controller 64(B). Because the operational mode of each of the X16 port controller 64(A) and to the X8 port controller 64(B) are the same, the control circuitry 62 performs time division multiplexing to allocate a first portion of time to the X16 port controller 64(A) and a second portion of time to the X8 port controller 64(B). In this case, the first portion of time and the second portion of time are equal portions of time and the control circuitry may interleave packets sent between the bridge circuitry 61 and the port controllers 64 with each packet using a 1024-bit CXS datapath.

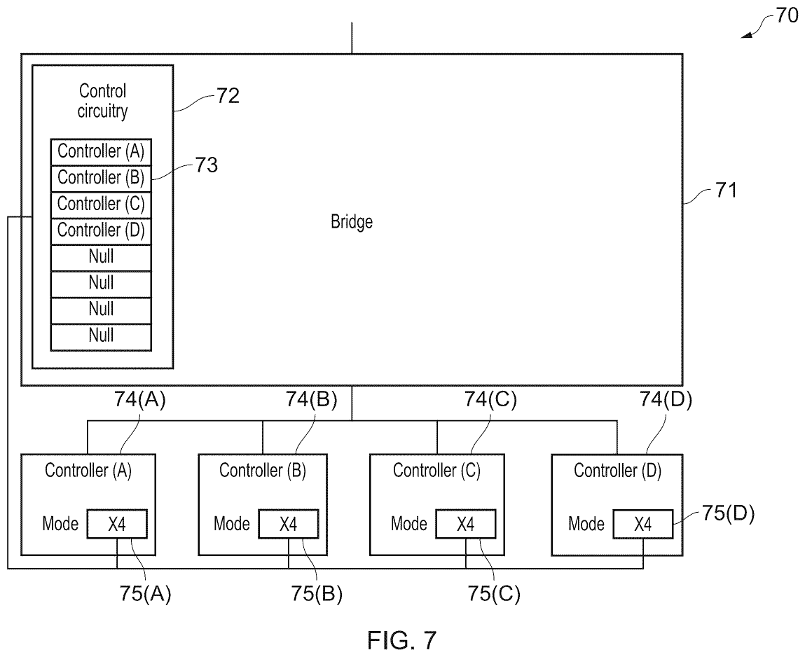

FIGS. 7 to 10 schematically illustrates use of an apparatus 70 to allocate a bandwidth share to port controllers 74 according to some configurations of the present techniques. The apparatus 70 is provided with bridge circuitry 71 and a plurality of port controllers 74. The port controllers 74 include a first port controller 74(A), a second port controller 74(B), a third port controller 74(C) and a fourth port controller 74(D). The port controllers 74 are operable in a plurality of different modes and may be configured, for example, as described in relation to FIG. 6. For example, the first port controller 74(A) may be configured as an X16 controller that is operable using any number of lanes up to 16; the second port controller 74(B) may be configured as an X8 controller that is operable using any number of lanes up to 8; the third port controller 74(C) may be configured as an X4 controller that is operable using any number of lanes up to 4; and the fourth port controller 74(D) may be configured as an X4 controller that is operable using any number of lanes up to 4.

In FIG. 7 the first port controller 74(A) is configured to operate in an X4 mode 75(A), the second port controller 74(B) is configured to operate in an X4 mode 75(B), the third port controller 74(C) is configured to operate in an X4 mode 75(C), and the fourth port controller 74(D) is configured to operate in an X4 mode 75(D). Configuration information indicating the modes of operation of each of the port controllers 74 is provided to the control circuitry 72 which is provided as part of the bridge circuitry 71. In this example, each of the four port controllers is operating in X4 mode and, hence, is allocated a same bandwidth share of the bandwidth quota. In the illustrated configuration, the allocation 73 comprises 8 possible time slots which are allocated to one of the four controllers. The control circuitry is configured to loop through the allocation 73 with time slots allocated a null value when those slots are not allocated to a controller. Time slots comprising a null value are skipped without any time being allocated to those slots. The control circuitry 72 determines a bandwidth allocation 73 in which each of the port controllers 74 is allocated a time slot for data transfer. In particular, the first port controller 74(A), the second port controller 74(B), the third port controller 74(C) and the fourth port controller 74(D) are each sequentially allocated a same duration time slot for data transfer. The control circuitry is configured to allow transfer for each of the port controllers 74 during its allocated time slot and is restricted so that it cannot transfer data outside of its allocated slot.

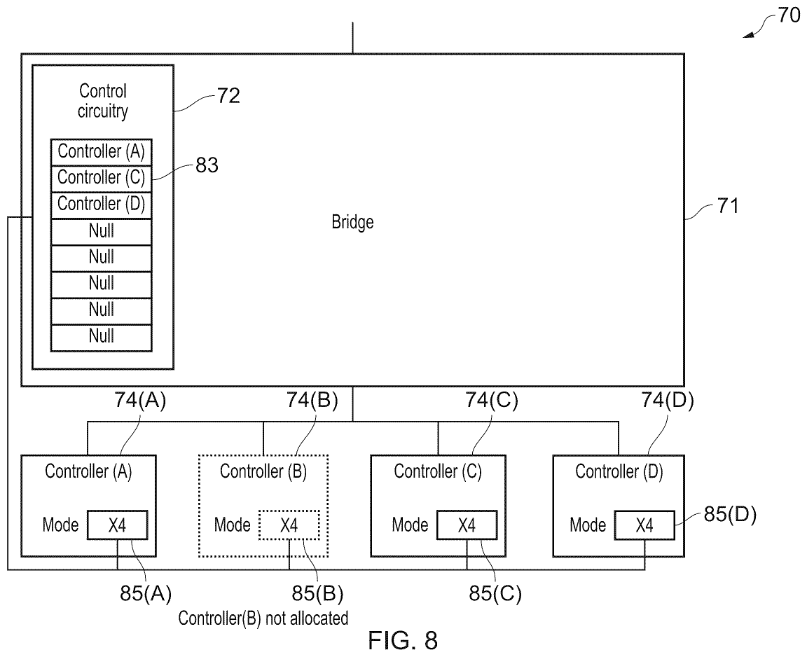

In FIG. 8 the first port controller 74(A) is configured to operate in an X4 mode 85(A), the second port controller 74(C) is not allocated, the third port controller 74(C) is configured to operate in an X4 mode 85(C), and the fourth port controller 74(D) is configured to operate in an X4 mode 85(D). Configuration information indicating the modes of operation of each of the port controllers 74 is provided to the control circuitry 72 which is provided as part of the bridge circuitry 71. In this example, three of the four port controllers are allocated and operating in X4 mode. However, the second port controller is not allocated. Hence, each of the three allocated port controllers 74 is allocated a same bandwidth share of the bandwidth quota and the second port controller 74(B), which is not allocated, is allocated a zero share of the bandwidth. The control circuitry 72 determines a bandwidth allocation 83 in which each of the allocated port controllers 74 is allocated a time slot for data transfer. In particular, the first port controller 74(A), the third port controller 74(C) and the fourth port controller 74(D) are each sequentially allocated a same duration time slot for data transfer. The control circuitry is configured to allow transfer for each of the port controllers 74 during its allocated time slot and is restricted so that it cannot transfer data outside of its allocated slot.

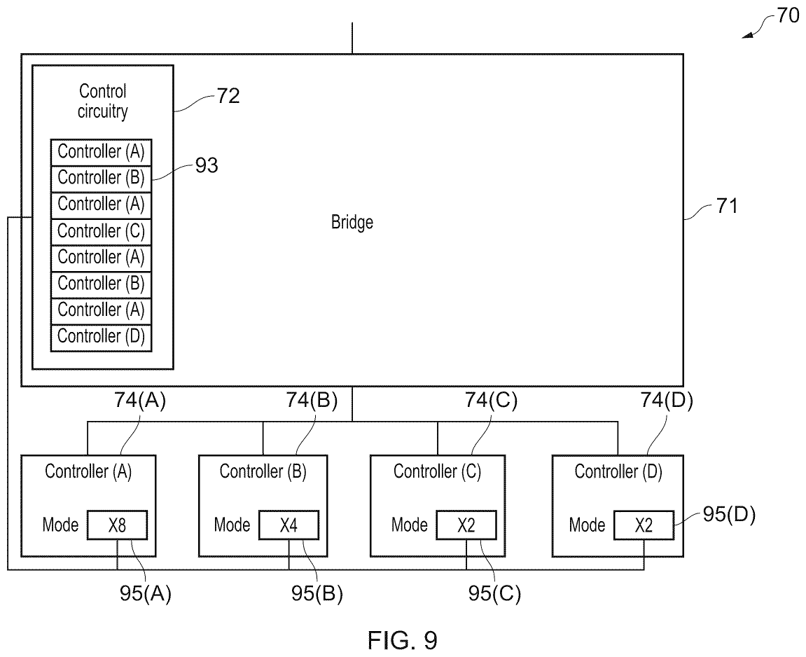

In FIG. 9 the first port controller 74(A) is configured to operate in an X8 mode 95(A), the second port controller 74(B) is configured to operate in an X4 mode 95(B), the third port controller 74(C) is configured to operate in an X2 mode 95(C), and the fourth port controller 74(D) is configured to operate in an X2 mode 95(D). Configuration information indicating the modes of operation of each of the port controllers 74 is provided to the control circuitry 72 which is provided as part of the bridge circuitry 71. In this example, some of the four port controllers are operating in a different mode. Hence, the bandwidth shares of the bandwidth quota allocated to some of the port controllers is different. The control circuitry 72 determines a bandwidth allocation 93 in which each of the port controllers 74 is allocated a time slot for data transfer. In particular, the first port controller 74(A) is allocated four times the bandwidth share of each of the third port controller 74(C) and the fourth port controller 74(D). The second port controller 74(B) is allocated twice the bandwidth share of each of the third port controller 74(C) and the fourth port controller 74(D). The control circuitry is configured to allow transfer for each of the port controllers 74 during its allocated time slot and is restricted so that it cannot transfer data outside of its allocated slot.

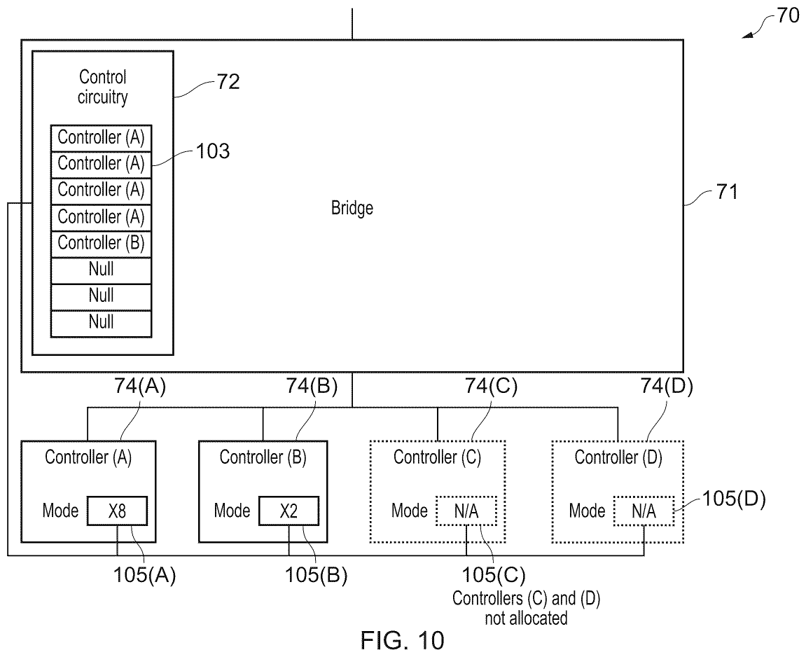

In FIG. 10 the first port controller 74(A) is configured to operate in an X8 mode 105(A), the second port controller 74(B) is configured to operate in an X2 mode 105(B), the third port controller 74(C) is not allocated, and the fourth port controller 74(D) is not allocated. Configuration information indicating the modes of operation of each of the port controllers 74 is provided to the control circuitry 72 which is provided as part of the bridge circuitry 71. In this example, some of the four port controllers are operating in a different mode. Hence, the bandwidth shares of the bandwidth quota allocated to some of the port controllers is different. The control circuitry 72 determines a bandwidth allocation 103 in which each of the port controllers 74 is allocated a time slot for data transfer. In particular, the first port controller 74(A) is allocated four times the bandwidth share of each of the second port controller 74(B). Each of the third port controller 74(C) and the fourth port controller 74(D) are not allocated and therefore do not receive any share of the bandwidth. The control circuitry is configured to allow transfer for each of the port controllers 74 during its allocated time slot and is restricted so that it cannot transfer data outside of its allocated slot.

It will be readily apparent to the skilled person that the order in which the time slots are allocated in each of FIGS. 7 to 10 can be changed. For example, in the illustrated configuration, the order of the allocated time slots could be reversed or rearranged. The null slots indicated in FIGS. 7 to 10 may contain any null value causing the control circuitry to skip that slot when allocating time. For example, in FIG. 10, four time slots are allocated to controller (A), one time slot is then allocated to controller (B), the next time slot is then allocated to controller (A) as the three remaining time slots each contain the null value.

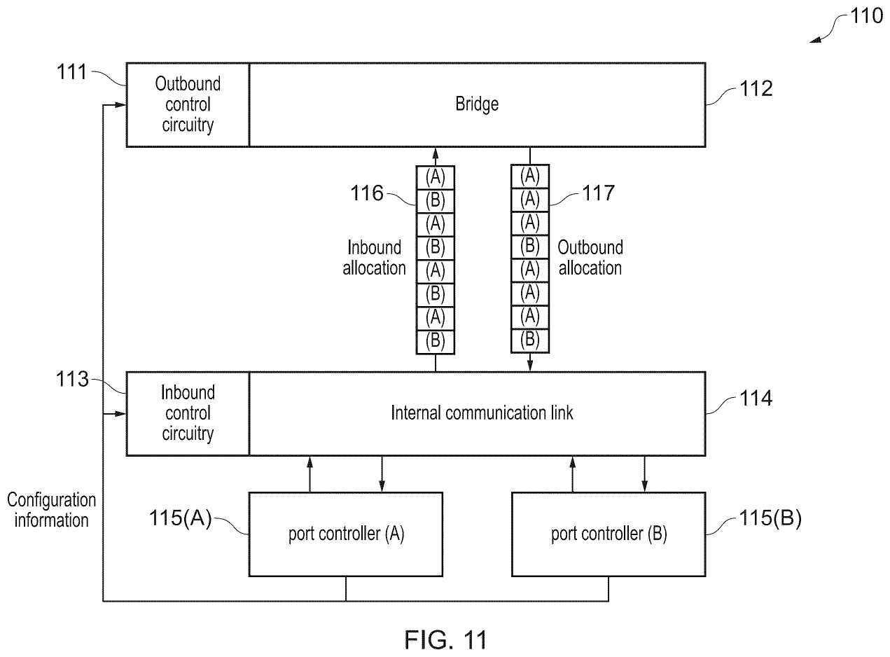

FIG. 11 schematically illustrates an apparatus 110 according to some configurations of the present techniques. The apparatus 110 is provided with bridge circuitry 112, internal communication link circuitry 114 and port controllers 115. The apparatus 110 is also provided with outbound control circuitry 111 and inbound control circuitry 113. The outbound control circuitry 111 is provided to determine the outbound bandwidth share allocation 117 for outgoing content. The inbound control circuitry 113 is provided to determine the inbound bandwidth share allocation 116 for the incoming content. The port controllers 115 which comprise a first port controller 115(A) and a second port controller 115(B), provide configuration information to the inbound control circuitry 113 and to the outbound control circuitry 111. The configuration information identifies the first port controller 115(A) and the second port controller 115(B) as being allocated and identifies the mode in which each of the first port controller 115(A) and the second port controller 115(B) are configured to operate. The inbound control circuitry 113 and the outbound control circuitry 111 are configured to determine the respective inbound allocation 116 and inbound allocation 117 independently from one another and may be based on different criteria and/or system conditions. In the illustrated configuration, the inbound allocation 116, which is determined by the inbound control circuitry 113, identifies an equal allocation to each of the first port controller 115(A) and the second port controller 115(B) with inbound content from each of the first port controller 115(A) and the second port controller 115(B) being interleaved during transmission to the bridge circuitry. The outbound allocation 117, which is determined by the outbound control circuitry 111, identifies a non-equal allocation to each of the first port controller 115(A) and the second port controller 115(B) with the first port controller 115(A) receiving three times the bandwidth compared to the second port controller 115(B).

It will be readily apparent to the skilled person that the allocation illustrated in FIG. 11 is provided for illustrative purpose only and that, the inbound allocation 116 and the outbound allocation 117 may be the same as one another.

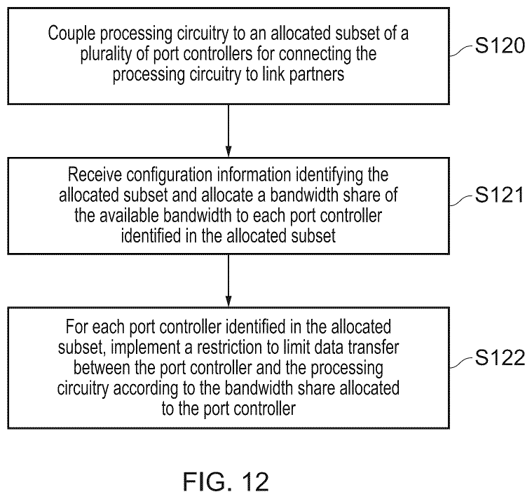

FIG. 12 schematically illustrates a sequence of steps carried out according to some configurations of the present techniques. Flow begins at step S120 where the processing circuitry is coupled to an allocated subset of a plurality of port controllers for connecting the processing circuitry to link partners. Flow then proceeds to step S121 where configuration information identifying the allocated subset is received and a bandwidth share of the available bandwidth (the bandwidth quota) is allocated to each of the port controllers identified in the allocated subset. Flow then proceeds to step S122 where, for each port controller identified in the allocated subset, a restriction is implemented to limit data transfer between the port controller and the processing circuitry according to the bandwidth share allocated to the port controller.

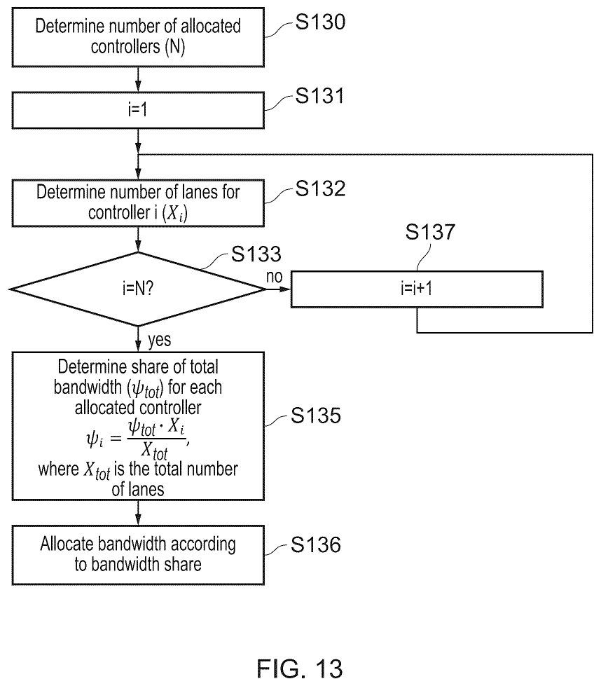

FIG. 13 schematically illustrates the allocation of bandwidth according to some configurations of the present techniques. Flow begins at step S130 where the number of port controllers that have been allocated is determined. Flow then proceeds to step S131 where variable i is initialised to i=1. Flow then proceeds to step S132 where the number of lanes for controller i is determined. The number of lanes for controller i is denoted Xᵢ. Flow then proceeds to step S133 where it is determined if i is equal to N, i.e., whether all allocated controllers have been considered. If, at step S133, it is determined that i is not equal to N, then flow proceeds to step S137 where i is incremented. Flow then returns to step S132. If, at step S133, it is determined that i is equal to N, then flow proceeds to step S135 where the share of the total bandwidth (tot) that is allocated to each allocated controller is determined. In particular, the share allocated to each controller is given by:

$${ψ}_{i} = \frac{{ψ}_{t o t} \cdot {X}_{i}}{{X}_{t o t}} ,$$

where Xₜₒₜ is the total number of lanes. Flow then proceeds to step S136 where the bandwidth is allocated according to the bandwidth share.

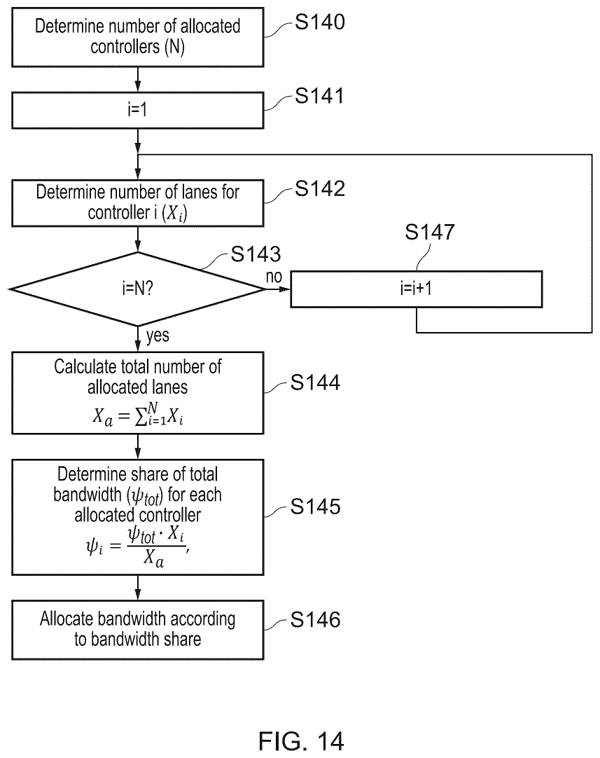

FIG. 14 schematically illustrates an alternative allocation of bandwidth according to some configurations of the present techniques. Flow begins at step S140 where the number of port controllers that have been allocated is determined. Flow then proceeds to step S141 where variable i is initialised to i=1. Flow then proceeds to step S142 where the number of lanes for controller i is determined. The number of lanes for controller i is denoted Xᵢ. Flow then proceeds to step S143 where it is determined if i is equal to N, i.e., whether all allocated controllers have been considered. If, at step S143, it is determined that i is not equal to N, then flow proceeds to step S147 where i is incremented. Flow then returns to step S142. If, at step S143, it is determined that i is equal to N, then flow proceeds to step S144 where the total number of allocated lanes is calculated by summing the lanes allocated to each allocated controller:

$${X}_{a} = {\sum }_{i = 1}^{N} {X}_{i} ,$$

flow then proceeds to step S145 where the share of the total bandwidth (ψₜₒₜ) that is allocated to each allocated controller is determined. In particular, the share allocated to each controller is given by:

$${ψ}_{i} = \frac{{ψ}_{t o t} \cdot {X}_{i}}{{X}_{a}} .$$

Flow then proceeds to step S146 where the bandwidth is allocated according to the bandwidth share.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

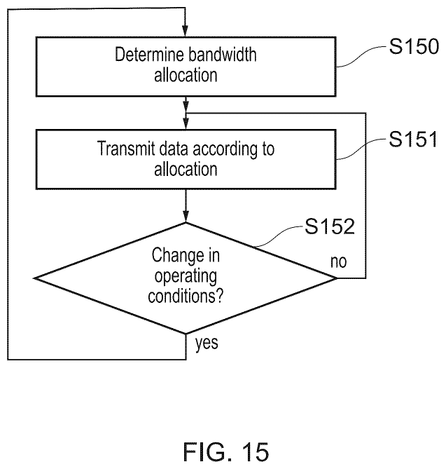

As shown in FIG. 15, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising bridge circuitry to couple processing circuitry to an allocated subset of a plurality of port controllers for connecting the processing circuitry to link partners. The bridge circuitry is configured to perform a data transfer between the processing circuitry and the allocated subset according to a bandwidth quota. The apparatus is provided with control circuitry to receive configuration information identifying the allocated subset, and to allocate a bandwidth share to each port controller identified in the allocated subset. The control circuitry is configured to determine the bandwidth share based on the configuration information. The control circuitry is configured, for each given port controller identified in the allocated subset, to implement a restriction to limit the data transfer between the given port controller and the processing circuitry according to the bandwidth share allocated to the given port controller.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
bridge circuitry configured to couple processing circuitry to an allocated subset of a plurality of port controllers for connecting the processing circuitry to link partners, wherein the bridge circuitry is configured to perform a data transfer between the processing circuitry and the allocated subset according to a bandwidth quota; and
control circuitry configured to receive configuration information identifying the allocated subset, and to allocate a bandwidth share of the bandwidth quota to each port controller identified in the allocated subset,
wherein the control circuitry is configured:
to determine the bandwidth share that is allocated to each port controller based on the configuration information; and
for each given port controller identified in the allocated subset, to implement a restriction to limit the data transfer between the given port controller and the processing circuitry according to the bandwidth share allocated to the given port controller.

Clause 2. The apparatus of clause 1, wherein:
at least two of the plurality of port controllers are configured to provide external communication links to respective ones of the link partners, each of the external communication links having a potential bandwidth different from one another;
the configuration information identifies the potential bandwidth provided by each of the port controllers; and
the bandwidth share allocated to each port controller is dependent on the potential bandwidth provided by each of the port controllers.

Clause 3. The apparatus of clause 2, wherein the control circuitry is configured to determine the bandwidth share allocated to the given port controller based on a ratio of the potential bandwidth of the given port controller to a sum of the potential bandwidth of all port controllers in the allocated subset.

Clause 4. The apparatus of clause 2 or clause 3, wherein:
at least one port controller of the plurality of port controllers is operable in a plurality of possible configurations, each of the plurality of possible configurations providing a different potential bandwidth; and
the control circuitry is configured to determine the potential bandwidth identified in the configuration information for the at least one port controller based on the configuration in which the at least one port controller is operating.

Clause 5. The apparatus of any preceding clause, wherein the bridge circuitry is configured to implement the restriction by multiplexing between the data transfer for each port controller of the allocated subset.

Clause 6. The apparatus of clause 5, wherein the multiplexing is time division multiplexing.

Clause 7. The apparatus of any preceding clause, wherein the control circuitry configured to allocate the bandwidth share to each port controller dynamically based on one or more system parameters.

Clause 8. The apparatus of clause 7, wherein the one or more system parameters comprises at least one of:
thermal parameters indicative of thermal conditions of the link partners coupled to each port controller of the allocated subset;
error conditions indicated on the link partners coupled to each port controller of the allocated subset; and
link quality parameters indicative of a stability of an external communication link between each port controller and the link partners.

Clause 9. The apparatus of any of clauses 1 to 6, wherein the control circuitry configured to allocate the bandwidth share to each port controller statically based on a boot time parameter.

Clause 10. The apparatus of any preceding clause, wherein the control circuitry is responsive to a congestion indication that an amount of data stored in a buffer associated with one of the port controllers of the allocated subset has exceeded a threshold, to reduce transmission of outbound data to that one of the port controllers.

Clause 11. The apparatus of any preceding clause, wherein each of the plurality of port controllers is configured to control communication, via an external communication link for communicating with one of the link partners, of external link protocol packets defined according to an external link protocol.

Clause 12. The apparatus of clause 11, wherein the bridge circuitry is coupled to each of the plurality of port controllers via an internal communication link configured to use an internal link protocol, different from the external link protocol, to transport the external link protocol packets between the bridge circuitry and the port controller.

Clause 13. The apparatus of clause 11 or clause 12, wherein the external link protocol comprises an input/output interface protocol.

Clause 14. The apparatus of any of clauses 11 to 13, wherein the external link protocol comprises a PCIe-based protocol.

Clause 15. The apparatus of any of clauses 11 to 14, wherein the external link protocol packets comprise PCIe transaction layer packets.

Clause 16. The apparatus of any of clauses 11 to 15 wherein:
the control circuitry is outbound control circuitry, the bandwidth quota is an outbound bandwidth quota, and the bandwidth share is an outbound bandwidth share of the outbound bandwidth quota for outbound data transferred from the processing circuitry to the allocated subset; and
the internal communication link comprises inbound control circuitry configured to allocate an inbound bandwidth share of an inbound bandwidth quota for inbound data transferred from the allocated subset to the processing circuitry.

Clause 17. The apparatus of clause 16, wherein the inbound bandwidth quota and the outbound bandwidth quota are different.

Clause 18. The apparatus of clause 16 or clause 17, wherein the inbound control circuitry allocates the inbound bandwidth share independent from the outbound control circuitry.

Clause 19. The apparatus of any of clauses 16 to 18, wherein for at least one port controller in the allocated subset, the outbound control circuitry and the inbound control circuitry are configured to support an inbound bandwidth share different from the outbound bandwidth share.

Clause 20. The apparatus of any preceding clause, comprising the plurality of port controllers, and an internal interface configured to couple each of the plurality of port controllers to the bridge circuitry.

Clause 21. The apparatus according to clause 20, wherein the port controller comprises data link layer encoding/decoding circuitry configured to encode/decode PCIe data link layer information for transporting on the external communication link.

Clause 22. A system comprising:
the apparatus according to any preceding clause, implemented in at least one packaged chip;
at least one system component; and
a board,
wherein the at least one packaged chip and the at least one system component are assembled on the board.

Clause 23. A chip-containing product comprising the system of clause 22, wherein the system is assembled on a further board with at least one other product component.

Clause 24. Computer-readable code for fabrication of the apparatus according to any of clauses 1 to 21.

Clause 25. A method comprising:
coupling, with bridge circuitry, processing circuitry to an allocated subset of a plurality of port controllers for connecting the processing circuitry to link partners, wherein the bridge circuitry is configured to perform a data transfer between the processing circuitry and each port controller of the allocated subset according to a bandwidth quota;
receiving configuration information identifying the allocated subset, and allocating a bandwidth share of the bandwidth quota to each port controller identified in the allocated subset, wherein the bandwidth share that is allocated to each port controller is determined based on the configuration information; and
for each given port controller identified in the allocated subset, implementing a restriction to limit the data transfer between the given port controller and the processing circuitry according to the bandwidth share allocated to the given port controller.

1. An apparatus comprising:
bridge circuitry configured to couple processing circuitry to an allocated subset of a plurality of port controllers for connecting the processing circuitry to link partners, wherein the bridge circuitry is configured to perform a data transfer between the processing circuitry and the allocated subset according to a bandwidth quota; and
control circuitry configured to receive configuration information identifying the allocated subset, and to allocate a bandwidth share of the bandwidth quota to each port controller identified in the allocated subset,
wherein the control circuitry is configured:
to determine the bandwidth share that is allocated to each port controller based on the configuration information; and
for each given port controller identified in the allocated subset, to implement a restriction to limit the data transfer between the given port controller and the processing circuitry according to the bandwidth share allocated to the given port controller.

2. The apparatus of claim 1, wherein:
at least two of the plurality of port controllers are configured to provide external communication links to respective ones of the link partners, each of the external communication links having a potential bandwidth different from one another;
the configuration information identifies the potential bandwidth provided by each of the port controllers; and
the bandwidth share allocated to each port controller is dependent on the potential bandwidth provided by each of the port controllers.

3. The apparatus of claim 2, wherein the control circuitry is configured to determine the bandwidth share allocated to the given port controller based on a ratio of the potential bandwidth of the given port controller to a sum of the potential bandwidth of all port controllers in the allocated subset.

4. The apparatus of claim 2, wherein:
at least one port controller of the plurality of port controllers is operable in a plurality of possible configurations, each of the plurality of possible configurations providing a different potential bandwidth; and
the control circuitry is configured to determine the potential bandwidth identified in the configuration information for the at least one port controller based on the configuration in which the at least one port controller is operating.

5. The apparatus of claim 1, wherein the bridge circuitry is configured to implement the restriction by multiplexing between the data transfer for each port controller of the allocated subset.

6. (canceled)

7. The apparatus of claim 1, wherein the control circuitry configured to allocate the bandwidth share to each port controller dynamically based on one or more system parameters.

8. The apparatus of claim 7, wherein the one or more system parameters comprises at least one of:
thermal parameters indicative of thermal conditions of the link partners coupled to each port controller of the allocated subset;
error conditions indicated on the link partners coupled to each port controller of the allocated subset; and
link quality parameters indicative of a stability of an external communication link between each port controller and the link partners.

9. The apparatus of claim 1, wherein the control circuitry configured to allocate the bandwidth share to each port controller statically based on a boot time parameter.

10. The apparatus of claim 1, wherein the control circuitry is responsive to a congestion indication that an amount of data stored in a buffer associated with one of the port controllers of the allocated subset has exceeded a threshold, to reduce transmission of outbound data to that one of the port controllers.

11. The apparatus of claim 1, wherein each of the plurality of port controllers is configured to control communication, via an external communication link for communicating with one of the link partners, of external link protocol packets defined according to an external link protocol.

12. The apparatus of claim 11, wherein the bridge circuitry is coupled to each of the plurality of port controllers via an internal communication link configured to use an internal link protocol, different from the external link protocol, to transport the external link protocol packets between the bridge circuitry and the port controller.

13. (canceled)

14. (canceled)

15. (canceled)

16. The apparatus of claim 11 wherein:
the control circuitry is outbound control circuitry, the bandwidth quota is an outbound bandwidth quota, and the bandwidth share is an outbound bandwidth share of the outbound bandwidth quota for outbound data transferred from the processing circuitry to the allocated subset; and
the internal communication link comprises inbound control circuitry configured to allocate an inbound bandwidth share of an inbound bandwidth quota for inbound data transferred from the allocated subset to the processing circuitry.

17. The apparatus of claim 16, wherein the inbound bandwidth quota and the outbound bandwidth quota are different.

18. The apparatus of claim 16, wherein the inbound control circuitry allocates the inbound bandwidth share independent from the outbound control circuitry.

19. The apparatus of claim 16, wherein for at least one port controller in the allocated subset, the outbound control circuitry and the inbound control circuitry are configured to support an inbound bandwidth share different from the outbound bandwidth share.

20. The apparatus of claim 1, comprising the plurality of port controllers, and an internal interface configured to couple each of the plurality of port controllers to the bridge circuitry.

21. (canceled)

22. A system comprising:
the apparatus according to claim 1, implemented in at least one packaged chip;
at least one system component; and
a board,
wherein the at least one packaged chip and the at least one system component are assembled on the board.

23. A chip-containing product comprising the system of claim 22, wherein the system is assembled on a further board with at least one other product component.

24. A non-transitory computer-readable medium storing computer-readable code for fabrication of an apparatus comprising:
bridge circuitry configured to couple processing circuitry to an allocated subset of a plurality of port controllers for connecting the processing circuitry to link partners, wherein the bridge circuitry is configured to perform a data transfer between the processing circuitry and the allocated subset according to a bandwidth quota; and
control circuitry configured to receive configuration information identifying the allocated subset, and to allocate a bandwidth share of the bandwidth quota to each port controller identified in the allocated subset,
wherein the control circuitry is configured:
to determine the bandwidth share that is allocated to each port controller based on the configuration information; and
for each given port controller identified in the allocated subset, to implement a restriction to limit the data transfer between the given port controller and the processing circuitry according to the bandwidth share allocated to the given port controller.

25. A method comprising:
coupling, with bridge circuitry, processing circuitry to an allocated subset of a plurality of port controllers for connecting the processing circuitry to link partners, wherein the bridge circuitry is configured to perform a data transfer between the processing circuitry and each port controller of the allocated subset according to a bandwidth quota;
receiving configuration information identifying the allocated subset, and allocating a bandwidth share of the bandwidth quota to each port controller identified in the allocated subset, wherein the bandwidth share that is allocated to each port controller is determined based on the configuration information; and
for each given port controller identified in the allocated subset, implementing a restriction to limit the data transfer between the given port controller and the processing circuitry according to the bandwidth share allocated to the given port controller.
